(19) United States
(12) Patent Application Publication
(10) Pub. No.: US 2020/0367528 A1
(43) Pub. Date: Nov. 26, 2020

(54) MICROCROP-DERIVED ELECTROLYTE DRINK, DRIED BASE POWDER, AND MILK, AND METHODS FOR GENERATING THE SAME

(71) Applicant: PARABEL NUTRITION, INC., Vero Beach, FL (US)

(72) Inventors: Peter Sherlock, Indialantic, FL (US); Ebenezer Ifeduba, Palm Bay, FL (US)

(21) Appl. No.: 16/882,066

(22) Filed: May 22, 2020

Related U.S. Application Data
(60) Provisional application No. 62/852,754, filed on May 24, 2019.

(51) Int. Cl. A23J 1/00; B01D 61/14; B01D 61/02; B01J 41/09; B01J 41/14; A23L 2/38

(52) U.S. Cl. CPC A23J 1/006; B01D 61/145; A23L 2/38; B01J 41/09; B01J 41/14; B01D 61/022

(57) ABSTRACT

The present disclosure relates, in some embodiments, to a method including demineralizing a protein liquor (i.e., a liquid portion of a lysed microcrop (e.g., Lemna) that has been separated to generate the liquid portion and a solid portion and having a composition including a soluble microcrop protein and a Vitamin B12) to generate a demineralized protein liquor. According to some embodiments, demineralizing the protein liquor may include diafiltration, ultrafiltration, nanofiltration, reverse osmosis filtration, electrodialysis, and/or passing the protein liquor through an ion exchange resin (e.g., an anion exchange resin. a trialkyl ammonium salt having three methyl groups). In some embodiments, a method may further include concentrating a demineralized protein liquor to generate at least one of a milk base and an electrolyte drink.

### CROSS REFERENCE TO RELATED APPLICATIONS

This application claims priority under 35 U.S.C. § 119(e) to U.S. Provisional Application No. 62/852,754, filed on May 24, 2019, which is hereby incorporated by reference in its entirety.

### FIELD OF THE DISCLOSURE

The present disclosure relates, in some embodiments, to protein, mineral, and/or Vitamin B12-rich beverages (e.g., an electrolyte drink, a microcrop milk) and a dried base powder, each derived from a microcrop and intended to serve as alternatives to traditional beverages and nutrient sources. A microcrop milk may serve as an alternative for mammalian milk (e.g., cow, goat) or plant-based milk products (e.g., almond milk, pea milk, soy milk).

The present disclosure further relates to methods for generating an electrolyte drink, a dried base powder, and/or a microcrop milk.

### BACKGROUND OF THE DISCLOSURE

An ever-increasing global population continues to fuel a plethora of sustainability concerns including sufficient and affordable access to protein sources for human consumption, including mammalian milk products. Dairy cattle in particular are a known contributor to increased global carbon emissions. Additionally, many consumers desire alternative milk products such as plant-based milk products as a solution to health and/or allergy concerns.

Besides sustainability issues, nutritionally viable mammalian alternatives are needed that contain adequate protein having a desirable amino acid profile and/or. Many plant-based protein products have inferior amino acid profiles. In contrast, a microcrop protein source can be used to generate high-protein beverages (e.g., mammalian protein product alternatives) having desirable amounts of protein with an enhanced amino acid profile containing all essential amino acids. Another issue frequently encountered with extracting plant-based protein is low protein yield due to protein inaccessibility, making it an inefficient endeavor with large quantities of waste products.

In addition, Vitamin B12 deficiency is prevalent in modern society and can result is serious health concerns including anemia. Traditional sources of Vitamin B12 include fish, meat, poultry, eggs, mammalian milk, and mammalian milk products. However, each of these sources of Vitamin B12 is riddled with the same sustainability concerns discussed above. Further, individuals with a vegan diet typically resort to supplementing their diets with a synthetic form of Vitamin B12 (e.g., Cyanocobalamin) which, unlike its naturally occurring counterparts (e.g., Adenosylcobalamin, Hydroxycobalamin, and Methylcobalamin), is not a bioactive form.

### SUMMARY

The present disclosure relates, in some embodiments, to a method including demineralizing a protein liquor (i.e., a liquid portion of a lysed microcrop (e.g., Lemna) that has been separated to generate the liquid portion and a solid portion and having a composition including a soluble microcrop protein and a Vitamin B12) to generate a demineralized protein liquor. According to some embodiments, demineralizing the protein liquor may include diafiltration, ultrafiltration, nanofiltration, reverse osmosis filtration, and/or passing the protein liquor through a hydrogen bonding and/or an ion exchange resin (e.g., PVPP, an anion exchange resin, a trialkyl ammonium salt having three methyl groups).

A method may further include, prior to the demineralizing, at least one of: subjecting a protein liquor to an adsorption process; adjusting a calcium concentration of a protein liquor; and filtering the protein liquor to remove insoluble materials. In some embodiments, an adsorption process may include mixing a polymer (e.g., a hydrogen bonding polymer, a polyvinylpolypyrrolidone) with a protein liquor.

In some embodiments, a method may further include concentrating a demineralized protein liquor to generate at least one of a milk base and an electrolyte drink. In some embodiments a milk base may be treated to reduce a microbial concentration and/or an enzymatic activity level. A method may include amending a milk base to generate an amended milk base by adding a fat component, adding an emulsifier, and/or adding an enhancer. An amended milk base may be homogenized to generate a microcrop milk. A method may further include drying at least one of a milk base and an electrolyte drink to generate a dried base powder.

According to some embodiments, a method may include generating a protein liquor including lysing a microcrop to generate a lysed biomass; separating the lysed biomass to generate a juice fraction and a solid fraction; and separating the juice fraction to generate the protein liquor. A lysed biomass may be hydrolyzed prior to separating in some embodiments.

### BRIEF DESCRIPTION OF THE DRAWINGS

Some embodiments of the disclosure may be understood by referring, in part, to the present disclosure and the accompanying drawings, wherein:

FIG. 1A is a flow diagram illustrating a system for generating a protein liquor from a microcrop, according to a specific example embodiment of the disclosure.

FIG. 1B is a flow diagram illustrating a system for further processing a microcrop, beginning with a protein liquor of FIG. 1A, according to a specific example embodiment of the disclosure.

### DETAILED DESCRIPTION

The present disclosure relates, in some embodiments, to protein-rich and/or nutrient-rich (e.g., Vitamin B12) products derived from a microcrop (e.g., an electrolyte drink, a dried base powder, a microcrop milk) and intended to serve as alternatives to traditional beverages. A microcrop milk may serve as an alternative for mammalian milk (e.g., cow, goat) or plant-based milk products (e.g., almond milk, pea milk, soy milk) providing a good source of protein, minerals, and Vitamin B12. An electrolyte drink derived from a microcrop may serve as an alternative source of minerals and Vitamin B12. The present disclosure further relates to methods for generating multiple products (e.g., an electrolyte drink, a dried base powder, a microcrop milk) from a microcrop.

According to some embodiments, beverages (e.g., electrolyte drink, microcrop milk) or dried base powder may be derived from one or more species of microcrop. A microcrop may comprise a single floating aquatic species (e.g., Lemna species, Salvinia species). A microcrop may include species of Lemna (e.g., duckweed, water lentil), Spirodela, Landoltia, Wolfiella, Salvinia (e.g., floating fern), Wolffia (e.g., watermeal), Azolla (e.g., mosquito fern), Pistia (e.g., water lettuce), or any combination thereof. According to some embodiments, a microcrop may be a species of Lemna, for example, Lemna minor, Lemna obscura, Lemna minuta, Lemna gibba, Lemna valdiviana, or Lemna aequinoctialis. A microcrop may comprise, according to some embodiments, a combination of two or more floating aquatic species. In some embodiments, a microcrop may be selected from a local aquatic species based on identified compositional and growth characteristics that have developed within the local environmental conditions. Local species may out-compete other species in open ponds or bioreactors based on their adaptation to the local environmental conditions. A microcrop, in some embodiments, may be adjusted in response to seasonal variations in temperature and light availability.

A microcrop may have characteristics that are advantageous in comparison to other aquatic species (e.g., rapid growth rate; reduced nutritional requirements; ease of harvesting and/or processing; enhanced amino acid profile; enhanced palatability; reduced evapotranspiration rate; increased protein composition, reduced oxalic acid content).

For example, Lemna is a genus of free-floating aquatic plants from the Lemnaceae family (e.g., duckweed) that grow rapidly. Lemna protein has an essential amino acid profile that more closely resembles animal protein than most other plant proteins. Table 1 shows a typical essential amino acid compositional profile of Lemna protein. Additionally, Lemna provides high protein yields, with freshly harvested Lemna containing up to about 43% protein by dry weight. Furthermore, compared with most other plants, Lemna leaves have a low fiber content (e.g., about 5% total solids with about 40% of the solids being carbohydrates consisting predominantly of soluble and insoluble fiber) and are highly digestible, even for monogastric animals.

TABLE 1
Essential Amino Acid Profile of Lemna Protein Concentration

| Essential Amino Acid | Protein (g/100 g) |
|---|---|
| Lysine | 5.9 |
| Leucine | 9.7 |
| Isoleucine | 5.1 |
| Methionine | 2.4 |
| Phenylalanine | 6.3 |
| Threonine | 4.4 |
| Tryptophan | 2.0 |
| Valine | 6.3 |
| Histidine | 2.7 |
| Arginine* | 6.8 |

*Conditionally non-essential amino-acid.

A microcrop (e.g., aquatic plant species, Lemna) may contain a nutritionally valuable concentration of Vitamin B12. In some embodiments, a microcrop may contain one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

### Microcrop Cultivation, Harvesting, and Preliminary Processing

The present disclosure further relates to the cultivation, harvesting, and preliminary processing of a microcrop that may be further processed to generate at least one of an electrolyte drink, a dried base powder, and a microcrop milk. A detailed description of processes by which a microcrop may be cultivated, harvested, and preliminarily processed can be found in U.S. patent application Ser. No. 16/803,792, U.S. Pat. No. 8,679,352, U.S. patent application Ser. Nos. 15/179,963, 15/751,826, and 15/263,253, each of which is incorporated herein by reference in its entirety as set forth in full. Moreover, persons skilled in the art would understand that there are multiple methods and systems directed to the cultivation, harvesting, and preliminary processing of a microcrop that would be applicable to the present disclosure. The descriptions provided above and incorporated herein are not limiting in this respect. For example, a microcrop may be cultivated under conditions that will alter the nutritional content of the microcrop species (e.g., reduced oxalic acid content) without deviating from the scope of the present disclosure.

As one example of the present disclosure, a detailed description of the processes by which a microcrop of the present disclosure may be harvested is found in U.S. patent application Ser. No. 16/803,792 (i.e., the '792 application), which is incorporated herein by reference in its entirety as set forth in full. As disclosed in the '792 application, a method of continuously supplying a harvested biomass comprising a floating aquatic plant species to a processing facility may comprise cultivating a microcrop (e.g., a floating aquatic plant species) in a bioreactor system, harvesting the microcrop to generate a harvested biomass, and conveying the harvested biomass to a first position of a harvest canal to form a conveyed biomass. A harvest canal may include a trough configured to contain the conveyed biomass in a volume of a medium, a canopy configured to provide at least an 80% reduction in solar radiation compared to the external surface of the canopy, and a propulsion mechanism configured to impart a motion on the first medium such that the harvested biomass may be transported from the first position to the second position within the harvest canal. The harvest canal may be positioned adjacent to an outer perimeter of bioreactor system and form an infinity loop. The method may further include activating the propulsion mechanism to impart motion on the first medium and propel the harvested biomass from the first position to the second position, and transferring at least a portion of the propelled biomass from the second position of the harvest canal to a processing facility. The propelled biomass of the '792 application may comprise a harvested microcrop of the instant disclosure, in some embodiments.

Additionally, a harvested microcrop may be preliminarily processed (e.g., washing 101 to remove contaminant, soaking to reduce oxalic acid content) without deviating from the scope of the present disclosure. For example, in some embodiments, a harvested microcrop may undergo a wash procedure 101 to remove excess growth medium, debris, contaminants, microorganisms, and/or toxins. As another example, a harvested microcrop may be soaked or buffered in a solution having an adjusted ion content as described in U.S. patent application Ser. No. 15/263,253, which is incorporated herein by reference in its entirety as set forth in full, without deviating from the present disclosure.

In some embodiments a harvested microcrop may be lysed 102 to form a lysed biomass 301. A detailed description of processes by which a microcrop may be lysed 102 can be found in U.S. patent application Ser. Nos. 13/050,931, 15/179,963, 15/263310, and 15/751,826, each of which is incorporated herein by reference in its entirety as set forth in full. In some embodiments one or more of water 205 (e.g., reverse osmosis water), calcium salt 206, and an antioxidant 207 (e.g., sodium metabisulfite) may be added to a microcrop prior to or during a lysing process 102. The addition of water 205 to a lysed biomass 301 may enhance solubility of protein components. In some embodiments an alkali (e.g., calcium hydroxide, sodium hydroxide) may be added to a microcrop prior to or during a lysing process 301. The addition of an alkali to a biomass (e.g., lysed biomass) may enhance solubility of protein components.

According to some embodiments, at least some soluble oxalic acid may be removed from a lysed biomass by converting the oxalic acid to an oxalate (e.g., calcium oxalate) and precipitating the oxalate from the lysed biomass (e.g., lysed biomass 301). In some embodiments, precipitating an oxalate from a lysed biomass may include mixing at least a portion of the lysed biomass with at least one calcium salt (e.g., calcium chloride, calcium acetate, calcium hydroxide). Precipitating an oxalate from a lysed biomass, in some embodiments, may include mixing at least a portion of the lysed biomass with a calcium chloride, calcium acetate, or calcium hydroxide solution. Precipitated insoluble oxalate may be removed from the liquid by centrifugation and/or filtration, according to some embodiments.

One or more antioxidants 207 (e.g., sodium metabisulfite, rosemary extract) antioxidants may be added to a microcrop prior to or during a lysing process 102 to reduce oxidation of the lysed biomass 301 and downstream products (e.g., a microcrop milk 332, a dried base powder 334, an electrolyte drink 330). A person having skill in the art would understand that one or more antioxidants 207 may be added to various stages of the disclosed process resulting in a decreased level of oxidation of the disclosed products without deviation from the present disclosure.

According to some embodiments, a lysed biomass 301 may be hydrolyzed 103. Hydrolysis 103 may include adding one or more non-proteolytic enzymes 208 (e.g., pectinase, cellulase, amylase) to the lysed biomass and incubating the mixture at a selected temperature for a selected period of time. A variety of non-proteolytic enzymes 208 may be selected without deviation from the present disclosure. For example, enzymes may be selected for their ability to degrade carbohydrates, fats, fiber, pectin, and other non-protein/peptide cellular materials. An incubation temperature and incubation time may be selected to maximize the effectiveness of the non-proteolytic enzyme(s) selected while minimizing protein degradation. For example, in one embodiment, one or more non-proteolytic enzymes may be added to a lysed biomass and the mixture may be incubated at approximately 50° C. for about 3 hours.

In some embodiments, a pH of a lysed biomass may be adjusted to improve hydrolysis. An adjustment of pH during hydrolysis 103 may be followed later with a corresponding opposite pH adjustment downstream of hydrolysis 103. In some embodiments, a hydrolyzed lysed biomass may be heat treated to deactivate the non-proteolytic enzymes used for hydrolysis 103 (e.g., enzyme combination 208, endogenous microcrop enzymes released during lysis).

Hydrolysis 103 of a lysed biomass may result in improved protein yields in downstream products (e.g., microcrop milk 332, electrolyte drink 330, dried base powder 334) when compared to products derived from a lysed biomass that was not hydrolyzed 103.

### Systems and Methods of Generating a Protein Liquor

### Generating a Protein Liquor

A lysed biomass (e.g., a lysed biomass 301, a hydrolyzed lysed biomass) may be separated 104 to generate a juice fraction 302 and a solid fraction 303. A juice fraction may include a protein-rich liquid and/or at least about some solid particles (e.g., carbohydrates, fiber). In some embodiments a lysed biomass may be diluted with a dilution fluid (e.g., water, recycled water, reverse osmosis water) prior to separation. A detailed description of processes by which a lysed biomass (e.g., a hydrolyzed lysed biomass) can be separated to generate a juice fraction 302 and a solid fraction 303 can be found in U.S. Pat. No. 13/050,931, Ser. Nos. 15/179,963, 15/263,310, and 15/751,826, each of which is incorporated herein by reference in its entirety as set forth in full.

In some embodiments, a juice fraction 302 may be directly processed as a protein liquor 305. A protein liquor is a substantially liquid composition derived from a microcrop and including dissolved microcrop protein. A protein liquor may have some residual solid composition (e.g., carbohydrates, fats, and a variety of phyto-nutritional compounds) and some undissolved protein content without deviating from this specification. In some embodiments, a juice fraction 302 may be separated to generate a protein liquor 305 and a first cake 306. A detailed description of processes by which a juice fraction may be separated to generate a protein liquor 305 and a first cake 306 can be found in U.S. Pat. No. 13/050,931, Ser. Nos. 15/179,963, 15/263,310, and 15/751,826, each of which is incorporated herein by reference in its entirety as set forth in full.

A solid fraction 303 may be further separated to extract additional juice (e.g., a first juice). Separation of a solid fraction may form a first juice 307 and a first solid 308. A first juice may include a protein-rich liquid and/or at least some solid particles (e.g., carbohydrates, fiber). A detailed description of processes by which a solid fraction may be separated to form a first juice and a first solid can be found in U.S. Pat. No. 13/050,931, Ser. Nos. 15/179,963, 15/263,310, and 15/751,826, each of which is incorporated herein by reference in its entirety as set forth in full.

According to some embodiments, a process for growing, harvesting, and separating a microcrop (e.g., aquatic plant species, Lemna, algal species) may be single cycle and at least one of a first cake 306 and a second cake 309 which are collected at other stages in the cycle (e.g., separation of a juice fraction yields a first cake) may be combined with a first solid to form a solid mixture, and the solid mixture may be further processed.

In some embodiments a process for growing, harvesting, and separating a microcrop (e.g., aquatic plant species, Lemna) may be multiple cycles or a continuous process such that one or more of a first cake and a second cake that are collected in an earlier cycle may be combined with a solid fraction from a subsequent cycle prior to separation of the solid fraction.

Increasing the extraction of a first juice from a solid fraction may decrease the overall moisture content of a first solid and may thereby lower the energy expenditure required to further process the first solid (e.g., energy required to dry). Additionally, increasing the extraction of juice from a solid fraction and/or solid mixture may improve the yield of a protein-rich product.

In some embodiments, further processing of a first cake 306 and a first juice 307 may be performed. Such additional processing may increase product yield and/or quality. In some embodiments, a first cake and a first juice may be combined and further separated 105 to form a third juice (e.g., third juice 310) and a second cake (e.g., second cake 309). A first cake and a first juice may be independently subjected to further separation, according to some embodiments. A detailed description of processes by which a first cake, a second cake, or any combination thereof may be separated to form a third juice and a second cake can be found in U.S. Pat. No. 13/050,931, Ser. Nos. 15/179,963, 15/263,310, and 15/751,826, each of which is incorporated herein by reference in its entirety as set forth in full. A protein liquor may be generated by any number of methods for processing a microcrop. Such methods may include: cultivating a microcrop; harvesting a microcrop; preliminary processing of a microcrop (e.g., washing, soaking, buffering); lysing a microcrop; and separating a microcrop (e.g., lysed, whole) to form a juice fraction and a solid fraction. A detailed description of processes by which a microcrop may be cultivated, harvested, preliminarily processed, lysed, and separated, in accordance with some embodiments of the present disclosure, can be found in U.S. Pat. No. 8,679,352, U.S. patent application Ser. Nos. 15/179,963, 15/751,826, and 15/263,253, each of which is incorporated herein by reference in its entirety as set forth in full. However, persons skilled in the art would appreciate that any number of methods may be used to generate a protein liquor and this disclosure is not limited to those explicitly described herein or incorporated by reference.

As one example, a detailed description of the processes by which a protein liquor 305 of the present disclosure may be generated is found in U.S. Pat. No. 8,679,352 (i.e., the '352 patent), which is incorporated herein by reference in its entirety as set forth in full. As disclosed in the '352 patent, a method of processing a microcrop comprising one or more protein separation steps (e.g., centrifugation, precipitation, coagulation) may result in a protein concentrate and a liquor (e.g., liquor, wash-liquor). In accordance with the '352 patent a protein concentrate may be further processed to generate a dry protein concentrate, while a liquor (e.g., liquor, wash-liquor) may be recycled to growth ponds to be used as a growth medium for a microcrop. A liquor (e.g., liquor, wash-liquor) generated from a method of processing a microcrop disclosed in the '352 patent may comprise a protein liquor 305 of the instant disclosure, in some embodiments.

In another example of the present disclosure, a detailed description of the processes by which a protein liquor 305 may be generated is found in U.S. patent application Ser. No. 15/179,963 (i.e., the '963 application), which is incorporated herein by reference in its entirety as set forth in full. In accordance with the '963 application, an extraction of protein and carbohydrate rich products from a microcrop may comprise one or more separation steps, wherein a juice (e.g., juice fraction, protein liquor, first juice, third juice) from a lysed microcrop may be separated from a solid (e.g., solid fraction, first solid, first cake, second cake). A solid (e.g., solid fraction, first solid, first cake, second cake) may be further processed to generate more juice or a carbohydrate rich product, while a juice (e.g., juice fraction, protein liquor, first juice, third juice) may be further processed (e.g., by one or more filtrations) to generate a protein rich product. A juice (e.g., juice fraction, protein liquor, first juice, third juice) generated from a process for extracting protein and carbohydrate rich products from a microcrop disclosed in the '963 application may comprise a protein liquor 305 of the instant disclosure, in some embodiments.

A protein liquor of the present disclosure may further comprise a reject stream (i.e., reject stream, first reject stream, second reject stream, permeate) from a process for extracting protein and carbohydrate rich products from a microcrop as described in the '963 application. In accordance with the '963 application an extraction of protein and carbohydrate rich products from a microcrop may comprise one or more filtration steps, wherein a juice containing a high protein concentration may be filtered to produce a soluble protein product and a reject stream (e.g., reject stream, first reject stream, second reject stream, permeate). The '963 application describes that a soluble protein product may then be further processed to produce a protein rich product, while a reject stream (e.g., reject stream, first reject stream, second reject stream, permeate) may be either recycled back into a bioreactor system, recycled into a wash solution, or further processed to generate a reject stream product. A reject stream (e.g. reject stream, first reject stream, second reject stream, permeate) of the '963 application may comprise a protein liquor 305 of the instant disclosure, in some embodiments.

In another embodiment of the present disclosure, a detailed description of the processes by which a protein liquor may be generated is found in U.S. patent application Ser. No. 15/751,826 (i.e., the '826 application), which is incorporated herein by reference in its entirety as set forth in full. In accordance with the '826 application an extraction of a reduced oxalic acid protein from a microcrop may comprise one or more separation steps, wherein a juice (e.g., juice fraction, protein liquor, first juice, third juice) from a lysed microcrop may be separated from a solid (e.g., solid fraction, first solid, first cake, second cake). A solid (e.g., solid fraction, first solid, first cake, second cake) may be further processed to generate more juice or a carbohydrate rich product, while a juice (e.g., juice fraction, protein liquor, first juice, second juice) may be further processed (e.g., by one or more filtrations, to generate a protein rich product). A juice (e.g., juice fraction, protein liquor, first juice, third juice) from a process for extracting a reduced oxalic acid protein from a microcrop of the '826 application may comprise a protein liquor 305 of the instant disclosure, in some embodiments.

A protein liquor 305 of the present disclosure may further comprise a reject stream (e.g., reject stream, first reject stream, second reject stream, permeate) from a process for extracting a reduced oxalic acid protein from a microcrop as described in the '826 application. In accordance with the '826 application, an extraction of a reduced oxalic acid protein from a microcrop may comprise one or more filtration steps, wherein a juice containing a high protein concentration may be filtered to produce a soluble protein product and a reject stream (e.g., reject stream, first reject stream, second reject stream, permeate). A soluble protein product may then be further processed to produce a protein rich product, while a reject stream (e.g., reject stream, first reject stream, second reject stream, permeate) may be either recycled back into a bioreactor system, recycled into a wash solution, or further processed to generate a reject stream product. A reject stream (e.g. reject stream, first reject stream, second reject stream, permeate) of the '826 application may comprise a protein liquor 305 of the instant disclosure, according to some embodiments.

In another example of the present disclosure, a detailed description of the processes by which a protein liquor may be generated is found in U.S. patent application Ser. No. 15/263,253 (the '253 application), which is incorporated herein by reference in its entirety as set forth in full. As disclosed in the '253 application processing of a high concentration protein product from a microcrop may comprise a blanching step, wherein a harvested microcrop is blanched, generating a wet protein concentrate and a blanching solution (e.g., blanching solution, filtered blanching solution, blanching waste). A wet protein concentrate may be further processed to produce a protein concentrate flour, while a blanching solution (e.g., blanching solution, filtered blanching solution, blanching waste) may be further filtered or recycled to an earlier step in the process. A blanching solution (e.g., blanching solution, filtered blanching solution, blanching waste) generated by a process described in the '253 application for generating a high concentration protein product from a microcrop may comprise a protein liquor 305 of the instant disclosure.

### Composition of a Protein Liquor

A protein liquor 305 may have soluble proteins and other soluble, plant derived compounds together with insoluble complexes and aggregates generated by treatment.

Insoluble complexes and aggregates may include of protein, chlorophyll and other compounds. Additionally, a protein liquor 305 may include, without limitation, one or more of: water, minerals, ions, ash, fatty and organic acids, alcohols, chlorophylls, pigments, polyphenols, Vitamin B12, and cellular and/or organelle debris.

In some embodiments, a protein liquor 305 may be substantially free of chlorophylls thereby permitting the generation of a microcrop milk that lacks green coloration without the necessity of a distinct decoloration process (e.g., degreening). Method and systems for processing a protein liquor 305 may include a colorimetric measurement. In some embodiments, a colorimetric measurement may be based on International Commission on Illumination's L*a*b* (CIELAB) color space coordinates, wherein color is measured as three values: L* for the lightness from black (0) to white (100), a* from green (−) to red (+), and b* from blue (−) to yellow (+). Any measurement with an a* value >−1 is not perceived to be green. For example, a protein liquor 305 may have an a* value >−1.

In some embodiments, a protein liquor 305 may be substantially free of fatty acids. The composition of a protein liquor 305 may vary depending on the specific microcrop from which the protein liquor 305 was derived and/or the method by which a microcrop was processed to generate the protein liquor 305.

In some embodiments, a process may be configured or performed to achieve any desired protein yield (e.g., maximal yield, a selected yield) of a protein liquor 305. In some embodiments, a protein concentration of a protein liquor 305 is higher than about 10%, or higher than about 20%, or higher than about 30%, or higher than about 40%, or higher than about 45%, or higher than about 50%, or higher than about 55%, or higher than about 60%, or higher than about 65%, or higher than about 70% by dry mass basis (DMB) of a protein liquor 305. A remainder of a protein liquor 305 may include carbohydrates, fiber, fats, minerals, or any combination thereof.

In some embodiments, a protein liquor 305 may have a fat content from about 10% to about 40% by DMB of the microcrop milk. A protein liquor 305 may have a fat content of at least 10%, or at least 15%, or at least 20%, or at least 25%, or at least 30%, or at least 35%, or at least 40% by DMB of the microcrop milk in some embodiments.

According to some embodiments, a protein liquor 305 may include an ash content consisting of a residue containing inorganic mineral elements. An ash content in some embodiments may be determined by combusting a protein liquor 305 at a high temperature (e.g., ≥500° C.) to remove organic matter. A protein liquor 305 may have an ash content lower than about 2%, or lower than about 4%, or lower than about 6%, or lower than about 8%, or lower than about 10%, or lower than about 12%, or lower than about 13%, or lower than about 1% to about 15% by DMB of the protein liquor 305 in some embodiments.

According to some embodiments, a protein liquor 305 may have a carbohydrate of between about 10% and about 55% by DMB of the microcrop milk. A protein liquor 305 may have a carbohydrate content of about 10%, or about 15%, or about 20%, or about 25%, or about 30%, or about 35%, or about 40%, or about 45%, or about 50%, or about 55% by DMB of the microcrop milk, in some embodiments.

According to some embodiments, a protein liquor 305 may include Vitamin B12. In some embodiments, a protein liquor 305 may include one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

In some embodiments, a protein liquor may have a composition that is between about 20% and 65% protein, about 20% and 52% ash, about 0% and 10% fat, about 10% and 25% carbohydrates and other materials, and about 3 μg/100 g and 30 μg/100 g Vitamin B12. For example, protein liquors A, B, C, D, and E produced by the processes described herein may include the contents summarized in Table 2 below.

TABLE 2

| | Protein | Protein | Protein | Protein | Protein |
|---|---|---|---|---|---|
| Composition | Liquor A | Liquor B | Liquor C | Liquor D | Liquor E |
| Protein | 60% | 43% | 32% | 25% | 39% |
| Ash | 25% | 26% | 50% | 52% | 35% |
| Fat | 5% | 9% | 4% | 10% | 8% |
| Carbs/Other | 10% | 22% | 14% | 13% | 18% |
| Vitamin B12 | 17 ug/100 g | 9 ug/100 g | 3 ug/100 g | 22 ug/100 g | 30 ug/100 g |

According to some embodiments, a protein liquor 305 may be consumed and may constitute a product without further processing.

Methods and Systems of Processing a Protein Liquor to Generate a Milk Base and/or an Electrolyte Drink

The present disclosure further relates to methods of processing a protein liquor 305. According to some embodiments, a method of producing a microcrop milk may include: demineralization of a protein liquor to generate a milk base; adding a fat component and an emulsifier to the milk base to generate an amended milk base; and homogenization of the amended milk base to generate the microcrop milk. In some embodiments, one or more enhancers (e.g., flavoring, color augmentor, preservative, pH adjustment, citric acid) may be added to the milk base or amended milk base to alter (e.g., improve) the flavor, taste, mouth feel, smell, or appearance of the microcrop milk. In some embodiments, unit operations are chosen to achieve an appropriate blend and concentration of nutritional components, flavor, mouthfeel, and color, while maintaining an ionic strength consistent with a stable emulsion in the microcrop milk.

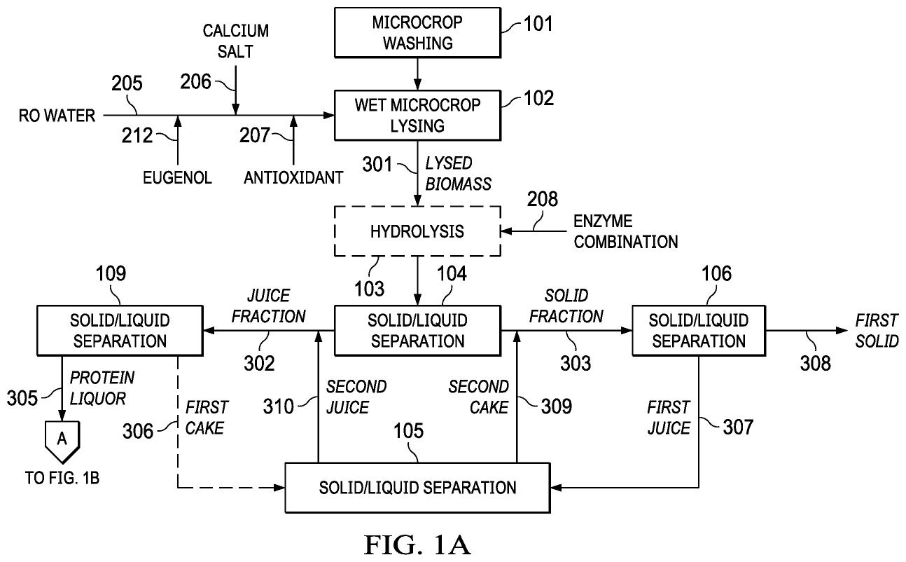

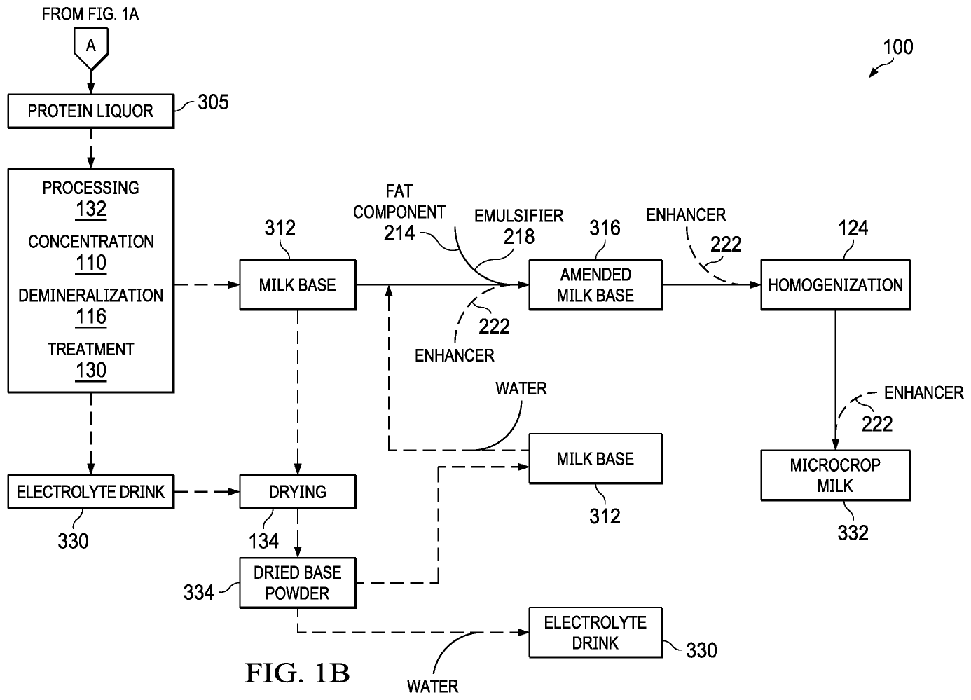

FIG. 1B illustrates an embodiment of a method 100 of processing a protein liquor 305.

### Processing of a Protein Liquor

A protein liquor 305 may contain components in concentrations which may be undesirable. For example, in high concentrations, some components may be undesirable because they may result in a product (e.g., high-protein beverage, dried base powder) with an unfavorable flavor or consistency (e.g., high saltiness, unstable emulsions, etc.). These components may be, without limitation, one or more of: excess water, minerals, ions, ash, fatty acids, alcohols, chlorophylls, polyphenols, cellular and/or organelle debris, residues, inorganic mineral elements, and other materials. Processing a protein liquor 305 may comprise one or more steps to remove or reduce the concentration of components from a protein liquor 305.

According to some embodiments, a protein liquor 305 may be high in ash content or ash-forming components, which may comprise a residue containing inorganic material elements, including ions. A high ash content may render the protein liquor 305 undesirable for use without further treatment (e.g., demineralization 116). Specifically, a high ash content of a protein liquor is detrimental to the stability of a microcrop milk resulting in undesirable separation. By reducing an ionic strength of a protein liquor through further processing of a protein liquor (e.g., demineralization 116) a microcrop milk may have improved stability in suspension.

In some embodiments, a protein liquor 305 may be processed prior to demineralization 116. According to some embodiments, a protein liquor may be processed to reduce a concentration of specific components (e.g., oxalic acid). In one embodiment, a protein liquor 305 may be processed to reduce an oxalic acid and/or oxalate content prior to demineralization. Processing a protein liquor, in some embodiments, may include adjusting a calcium composition of the protein liquor.

In some embodiments, a protein liquor may be configured to have a high calcium composition (e.g., a high calcium protein liquor). For example, a high calcium protein liquor may comprise a calcium concentration of ≤about 800 ppm, or ≤about 750 ppm, or ≤about 700 ppm, or ≤about 650 ppm, or ≤about 600 ppm, or ≤about 550 ppm, or ≤about 500 ppm, or ≤about 450 ppm, or ≤about 400 ppm, or ≤about 350 ppm, or ≤about 300 ppm, or ≤about 250 ppm, or ≤about 200 ppm, or ≤about 150 ppm, or ≤about 100 ppm, or ≤about 50 ppm. In some embodiments, a high calcium protein liquor may comprise a calcium concentration of about 50 ppm to about 200 ppm, or about 50 ppm to about 400 ppm, or about 50 ppm to about 600 ppm, or about 100 ppm to about 800 ppm, or about 100 ppm to about 700 ppm, or about 100 ppm to about 600 ppm, or about 100 ppm to about 500 ppm, or about 300 ppm to about 600 ppm, or about 200 ppm to about 800 ppm. A high calcium protein liquor, according to some embodiments, may comprise a calcium concentration of at most about 800 ppm (e.g., ±50 ppm). In some embodiments, a high calcium protein liquor may comprise a calcium concentration of at most about 600 ppm (e.g., ±50 ppm). In some embodiments, adjusting a protein liquor to have a high calcium concentration may impact the equilibrium between an oxalic acid concentration and an oxalate concentration (e.g., calcium oxalate). For example, adjusting a protein liquor to have a high calcium protein liquor may convert oxalic acid into oxalate.

According to some embodiments, adjustment of a protein liquor may result in a formation of insoluble materials (e.g., insoluble calcium oxalate), such insoluble materials can be removed in a liquid solid separation step (e.g., filtration) prior to demineralization. According to some embodiments, processing a protein liquor prior to demineralization may result in a protein liquor having a modified pH (e.g., where calcium hydroxide is added, an additional benefit may be an increase in pH prior to demineralization).

In some embodiments a protein liquor 305 may include one or more polyphenols which can contribute undesirable color (e.g., darken) to a protein liquor 305 and/or result in undesirable flavors in downstream products (e.g., electrolyte drink 330, dried base powder 334, milk base 312, microcrop milk 313). Accordingly, in some embodiments it may be desirable to remove polyphenols from a protein liquor 305 using an adsorption process. In some implementations, the removal of polyphenols from a protein liquor 305 may be carried out in a reactor vessel.

An adsorption process may be implemented using one or more polymers configured to bind polyphenols. According to one embodiment, an adsorption process may include mixing a polymer (e.g., a hydrogen bonding polymer, polyvinylpolypyrrolidone (PVPP)) with a volume of a protein liquor 305. For example, in some embodiments a polymer may be mixed with a protein liquor 305 at a ratio of 0.1 g of polymer/L of decolored permeate, or 0.5 g/L, or 0.8 g/L, or 1 g/L, or 1.5 g/L, or 2 g/L, or 2.5 g/L, or 3 g/L, or 3.5 g/L, or 4 g/L, or 4.5 g/L, or 5 g/L. According to some embodiments, an adsorption process may include continuously mixing a volume of a polymer with a volume of a protein liquor 305 for a specified period of time (e.g., 20 min, 1 hour, 2 hours). Specific ratios, volumes, and mixing times may be specific to the polymer selected and other parameters (e.g., amount of polyphenol content).

In some embodiments, processing (e.g., an adsorption process) 132 may include passing a protein liquor 305 through a hydrogen bonding and/or ion exchange resin prior to demineralization 116. In some embodiments, this may comprise passing a protein liquor 305 through a series (e.g., at least two, at least three) of hydrogen bonding and/or ion exchange resins. Each hydrogen bonding and/or ion exchange resin in a series may be the same or different than the other hydrogen bonding and/or ion exchange resins in the series. In some embodiments, a hydrogen bonding resin may comprise polyvinylpolypyrrolidone (PVPP). In some embodiments an ion exchange resin may be a strongly acidic resin, a strongly basic resin, a weakly acidic resin, a weakly basic resin, a weak anion exchange resin, a strong anion exchange resin, a weak cation exchange resin, a strong cation exchange resin, or any combination thereof. Appropriate anionic exchange resins may include, but are not limited to, those anion exchange resins which include a trialkyl ammonium salt. A trialkyl ammonium salt may include a functional group including a halide, an alkyl group selected from C1-C16 alkyl, an aryl, a branched chain alkyl, and a cycloalkyl. A halide may include one or more of a fluoride, a chloride, a bromide, and an iodide. According to some embodiments, an anion exchange resin may include a trialkyl ammonium salt having three methyl groups and a chloride, thereby forming a trimethylammonium chloride salt.

Hydrogen bonding and/or ion exchange resins may be used in a batch mode or arranged in a continuous process, whereby resins may be cycled through processing, demineralization, and regeneration processes.

### Demineralization of a Protein Liquor

Undesirable components may be removed from a protein liquor 305 to generate a milk base 312 and/or an electrolyte drink through demineralization 116. Demineralization 116, according to some embodiments, may comprise one or more of filtration (e.g., diafiltration, ultrafiltration, nanofiltration, reverse osmosis filtration), electrodialysis, selective ion precipitation, solvent washing, forward osmosis, chromatography, and the use of ion exchange resins. In some embodiments, a suitable NMWCO and/or filter (e.g., pore) size for filtration may vary depending on the required separation needed between higher and lower molecular weight components or molecular size to achieve the desired compositional balance for optimizing yield, taste, flavor, odor, and/or nutritional value.

In some embodiments, a protein liquor 305 may be filtered using microfiltration to generate a milk base 312 and/or an electrolyte drink 330. Microfiltration may reduce the concentration of suspended solids (e.g., fats, fiber, cellular debris), microbial contamination (e.g., Escherichia coli), and/or fungal contamination (e.g., yeast) in a milk base 312, according to some embodiments. Suitable filter sizes for microfiltration may include, in some embodiments, ≤about 10 μm, or ≤about 5 μm, or ≤about 3 μm, or ≤about 2 μm, or ≤about 1 μm, or ≤about 0.5 μm, or ≤about 0.4 μm, or ≤about 0.3 μm, or ≤about 0.2 μm, or ≤about 0.1 μm.

In some embodiments, a protein liquor 305 may be filtered using ultrafiltration to generate a milk base 312 and/or an electrolyte drink 330. Ultrafiltration may involve membrane filtration using pressure, concentration gradients, or a combination thereof. Suitable nominal molecular weight cut-offs (NMWCO) for ultrafiltration may be, in some embodiments, at most about 100 kDa, or at most about 90 kDa, or at most about 80 kDa, or at most about 70 kDa, or at most about 60 kDa, or at most about 55 kDa, or at most about 50 kDa, or at most about 45 kDa, or at most about 40 kDa, or at most about 30 kDa, or at most about 20 kDa, or at most about 15 kDa, or at most about 14 kDa, or at most about 13 kDa, or at most about 12 kDa, or at most about 11 kDa, or at most about 10 kDa, or at most about 9 kDa, or at most about 8 kDa, or at most about 7 kDa, or at most about 6 kDa, or at most about 5 kDa, or at most about 4 kDa, or at most about 3 kDa, or at most about 2 kDa, or at most about 1 kDa. In some embodiments, suitable NMWCO cut-offs for ultrafiltration may be in a range of at most about 1 kDa to at most about 10 kDa, at most about 2 kDa to at most about 10 kDa, at most about 3 kDa to at most about 10 kDa, at most about 3 kDa to at most about 15 kDa, or at most about 3 kDa to at most about 20 kDa, or at most about 3 kDa to at most about 60 kDa, or at most about 3 kDa to at most about 55 kDa, or at most about 10 kDa to at most about 55 kDa. In some embodiments a NMWCO for ultrafiltration may be at least 1 kDa, or at least 3 kDa, or at least 5 kDa, or at least 10 kDa, or at least 15 kDa, or at least 20 kDa, or at least 25 kDa, or at least 30 kDa, or at least 35 kDa, or at least 40 kDa, or at least 45 kDa, or at least 50 kDa, or at least 55 kDa. A suitable NMWCO for ultrafiltration may vary depending on a manufacturing specification of an ultrafilter. In some embodiments a suitable NMWCO for ultrafiltration may vary depending on a rate of hydrolysis

In some embodiments, a protein liquor 305 may be filtered using nanofiltration to generate a milk base 312 and/or an electrolyte drink 330. In some embodiments, suitable filter sizes for nanofiltration may include ≤about 0.01 μm, or ≤about 0.009 μm, or ≤about 0.008 μm, or ≤about 0.007 μm, or ≤about 0.006 μm, or ≤about 0.005 μm, or ≤about 0.004 μm, or ≤about 0.003 μm, or ≤about 0.002 μm, or ≤about 0.001 μm. A nanofiltration filter may have a filter size of not more than about 0.01 μm, in some embodiments. According to some embodiments, suitable filter sizes for nanofiltration may include ≤about 1000 Da, or ≤about 900 Da, or ≤about 800 Da, or ≤about 700 Da, or ≤about 600 Da, or ≤about 500 Da, or ≤about 400 Da, or ≤about 300 Da, or ≤about 200 Da, or ≤about 100 Da.

In some embodiments, a protein liquor 305 may be filtered using reverse osmosis filtration to generate a milk base 312 and/or an electrolyte drink 330. According to some embodiments, suitable filter sizes for reverse osmosis filtration may include ≤about 0.001 μm, ≤about 0.0009 μm, ≤about 0.0008 μm, ≤about 0.0007 μm, ≤about 0.0006 μm, ≤about 0.0005 μm, ≤about 0.0004 μm, ≤about 0.0003 μm, ≤about 0.0002 μm, or ≤about 0.0001 μm. A reverse osmosis filter may have a filter size of not more than about 0.001 μm, in some embodiments.

A person having skill in the art would understand that the selection of filter sizing used for filtration may be adjusted according to the desired product specifications. For example, a slightly larger filter size (e.g., 1 μm) may be acceptable where it would be acceptable for the desired downstream products from the protein liquor to have some chlorophyll content (e.g., chlorophyll and chlorophyll complexes) resulting in some green coloration of the product. Similarly, a smaller filter size (e.g., 500 kDa, 0.1 μm) may be acceptable where the desired downstream products from the protein liquor have little to no chlorophyll content (e.g., chlorophyll and chlorophyll complexes) and no discernible green coloration of the product; however, the use of smaller filter sizes may reduce yield of downstream products from the permeate. A person having skill in the art would understand the relationship between these trade-offs and select appropriate filter sizes for the desired results (e.g., product characteristics, yield).

According to some embodiments, demineralization 116 methods processing a protein liquor 305 may include passing a protein liquor 305 through a hydrogen bonding and/or ion exchange resin. In some embodiments, demineralization 116 may comprise passing a protein liquor 305 through a series (e.g., at least two, at least three) of hydrogen bonding and/or ion exchange resins. Each hydrogen bonding and/or ion exchange resin in a series may be the same or different than the other hydrogen bonding and/or ion exchange resins in the series. In some embodiments, a hydrogen bonding resin may comprise polyvinylpolypyrrolidone (PVPP). In some embodiments an ion exchange resin may be a strongly acidic resin, a strongly basic resin, a weakly acidic resin, a weakly basic resin, a weak anion exchange resin, a strong anion exchange resin, a weak cation exchange resin, a strong cation exchange resin, or any combination thereof. Appropriate anionic exchange resins may include, but are not limited to, those anion exchange resins which include a trialkyl ammonium salt. A trialkyl ammonium salt may include a functional group including a halide, an alkyl group selected from C1-C16 alkyl, an aryl, a branched chain alkyl, and a cycloalkyl. A halide may include one or more of a fluoride, a chloride, a bromide, and an iodide. According to some embodiments, an anion exchange resin may include a trialkyl ammonium salt having three methyl groups and a chloride, thereby forming a trimethylammonium chloride salt.

Hydrogen bonding and/or ion exchange resins may be used in a batch mode or arranged in a continuous process, whereby resins may be cycled through demineralization and regeneration processes. In some embodiments demineralization 116 may further comprise adjusting a pH of a protein liquor 305 or a product yielded from an ion exchange column (e.g., a milk base 312, electrolyte drink 330.).

According to one example embodiment, a pH value of a protein liquor may be adjusted to a value of about 8.5 to about 10 with ammonium hydroxide solution or other suitable base (28%-30%, w/w) or by an anion exchange resin in the free base [OH—] form. Next, the alkalinized protein liquor may be treated with a cation exchange resin in the protonated [H+] form to a pH not greater than 7.0 and not less than 4.0. The final pH of the demineralized protein liquor may be adjusted to a desired level by adding acid or base.

Demineralization 116 may comprise a selective ionic precipitation, according to some embodiments. A selective ionic precipitation may provide for the selective precipitation of undesirable ions, while leaving other, more desirable ions, in the protein liquor 305. Selective ionic precipitation may allow for the removal of metal ions, ash, and ash forming components without altering protein composition of a protein liquor 305. According to some embodiments, selective ionic precipitation may comprise an addition of anions or anionic acids to a protein liquor 305. According to some embodiments, an anion or anionic acid may comprise phosphate or phosphoric acid. Demineralization 116 by selective ionic precipitation may result in a precipitate and a product (e.g., milk base 312, electrolyte drink 330). Separation of a precipitate from a product (e.g., milk base 312, electrolyte drink 330) may comprise any one or more of filtration, ultrafiltration, nanofiltration, centrifugation, membrane filtration, evaporation, crystallization, decantation, or other means of separation.

An ash content of a product (e.g., milk base 312, electrolyte drink 330) may be determined by combusting the product at a high temperature (e.g., >500° C.) to remove organic matter. A product (e.g., milk base 312, electrolyte drink 330) may have an ash content less than about 50%, or less than about 40%, or less than about 30%, or less than about 25%, or less than about 20%, or less than about 15%, or less than about 10%, or less than about 5%, or less than about 4%, or less than about 3%, or less than about 2%, or less than about 1% by weight of the demineralized protein liquor in some embodiments. In some embodiments, product (e.g., milk base 312, electrolyte drink 330) may have an ash content from about 1% to about 10%, or from about 10% to about 20%, or from about 20% to about 30%, or from about 30% to about 40%, or from about 40% to about 50% by weight of the demineralized protein liquor. A product (e.g., milk base 312, electrolyte drink 330), in some embodiments, may have an ash content from about 1% to about 50%, or from about 2% to about 40%, or from about 3% to about 30%, or from about 3% to about 20%, or from about 3% to about 15%, or from about 3% to about 10%, or from about 5% to about 10%, or from about 5% to about 15% by weight of the product. A product (e.g., milk base 312, electrolyte drink 330) may be further processed to meet a desired ash content (e.g., higher or lower concentration, a desired ash composition).

A person having ordinary skill in the art will understand that various combinations of the above described demineralization process steps may be used to generate products (e.g., milk base, electrolyte drink) having distinct combinations of properties. By altering the combination of characteristics (e.g., ash content, ionic strength) a product may be more or less suitable for specific end uses. For example, a product having a high ash content may be unsuitable as a milk base as it would readily separate and thus be unpalatable to many consumers. Based on the present disclosure a person of ordinary skill could alter and combine the various processes described herein to generate ideal product characteristics without undue experimentation.

### Concentration of a Protein Liquor

A method of producing a milk base 312 and/or an electrolyte drink 330 may further comprise a concentration step 110. According to some embodiments, a concentration step 110 may comprise a process to reduce a moisture content of a protein liquor 305, a milk base 312, or both. In some embodiments, a concentration step 110 may be integrated into a demineralization step 116 (e.g., ion exchange, nanofiltration, reverse osmosis filtration) such that concentration 110 and demineralization 116 occur in a simultaneous, or virtually simultaneous, manner According to some embodiments, concentration 110 may comprise one or more of filtration, nanofiltration, reverse osmosis filtration, membrane filtration, and evaporation.

In some embodiments, a concentration step 110 comprises evaporation. Evaporation may be performed by, for example, a thermal (evaporative) means such as: a rising film evaporator, a falling film evaporator, a natural circulation evaporator (vertical or horizontal), an agitated-film evaporator, a multiple-effect evaporator, by vacuum evaporation, or any combination thereof. Heat may be supplied directly into the evaporator, or indirectly through a heat jacket. Heat may either come from a raw source (e.g., combustion of natural gas, steam from a boiler) or from a waste heat stream (e.g., dryer exhaust) or from heat transferred by cooling an input stream. In some embodiments, the heat added during a concentration step 110 comprising evaporation may effectively pasteurize the concentrated product (e.g., concentrated protein liquor, milk base). In some embodiments, concentration by evaporation may comprise more than one heating and cooling cycle.

A concentration step 110 may comprise a reduction in moisture content by nanofiltration or reverse osmosis filtration. In some embodiments, suitable filter sizes for nanofiltration may include ≤about 0.01 μm, or ≤about 0.009 μm, or ≤about 0.008 μm, or ≤about 0.007 μm, or ≤about 0.006 μm, or ≤about 0.005 μm, or ≤about 0.004 μm, or ≤about 0.003 μm, or ≤about 0.002 μm, or ≤about 0.001 μm. According to some embodiments, suitable filter sizes for reverse osmosis filtration may include ≤about 0.001 μm, ≤about 0.0009 μm, ≤about 0.0008 μm, ≤about 0.0007 μm, ≤about 0.0006 μm, ≤about 0.0005 μm, ≤about 0.0004 μm, ≤about 0.0003 μm, ≤about 0.0002 μm, or ≤about 0.0001 μm.

### Treatment of a Protein Liquor

In some embodiments a protein liquor (e.g., protein liquor 305) may be treated (e.g., heating) to inactivate or kill some or all microorganisms (e.g., bacteria, fungi, viruses) that may be present in a protein liquor (e.g., protein liquor 305). It is desirable to decrease a population of microorganisms present in a protein liquor as microorganisms can be pathogenic (e.g., Salmonella, E. coli, Listeria) and/or can contribute to spoilage of the protein liquor (e.g., decreased usable lifespan). Treatment of a protein liquor may decrease or eliminate microorganisms from a protein liquor thereby improving safety for human consumption and prolonging the shelf life of products generated using the protein liquor. In some embodiments, treatment may deactivate enzymes (e.g., endogenous microcrop enzymes, microbial enzymes) present in a protein liquor. Enzymes can contribute to spoilage of a protein liquor or contribute undesirable characteristics (e.g., flavors, colors) to downstream products; therefore, inactivating such enzymes can be desirable. Treatment of a protein liquor may result in an improved taste, odor, and color in downstream products compared to products generated from a protein liquor that was not subjected to the treatment.

Treatment may be performed using any method (e.g., pasteurization, heating to specific temperatures and maintaining said temperature for a specific time, high pressure homogenization) suitable for decreasing a microbial population or enzymatic load of a protein liquor to a desired level without resulting in unacceptable levels of degradation to a soluble protein present in a protein liquor.

Treatment may comprise heating (e.g., rapidly, slowly) a protein liquor (e.g., protein liquor 305) to a specific temperature (e.g., 70° C., 80° C.) and maintaining the protein liquor at the temperature for a sufficient period of time (e.g., 15 sec-1 min) to achieve the desired amount of microbial deactivation and/or enzymatic deactivation. For example, treatment may include pasteurization. However, treatment may also include processes which would not qualify as pasteurization per se due to the rapidity of heating, temperatures selected, or time retained at the designated temperature but which are still capable of achieving a sufficient amount of microbial deactivation and/or enzymatic deactivation to provide improved qualities to downstream products (e.g., expanded shelf life, improved flavor, reduced spoilage). Treatment may include sequentially heating a protein liquor to multiple temperatures with each temperature being held for a designated period of time where such periods of time may be the same or different from one another. A selected temperature may include one or more temperatures sufficient to destroy and/or inactivate microorganisms (e.g., pathogenic bacteria, yeast, mold, Salmonella, E. coli, Listeria) and/or enzymes. A selected temperature may include a temperature of about 5° C., or about 7° C., or about 10° C., or about 15° C., or about 20° C., or about 25° C., or about 30° C., or about 35° C., or about 40° C., or about 45° C., or about 50° C., or about 55° C., or about 60° C., or about 65° C., or about 70° C., or about 75° C., or about 80° C., or about 85° C., or about 90° C. A protein liquor may be held at the selected temperature for a sufficient period of time to achieve the desired amount of microbial deactivation and/or enzymatic deactivation. In some embodiments, treatment may be carried out using at least a steam injection heat exchanger.

Treatment may include high pressure homogenization for a sufficient period of time to achieve the desired amount of microbial deactivation and/or enzymatic deactivation.

In some embodiments a protein liquor (e.g., protein liquor 305) may be cooled (e.g., rapidly) to a cooled temperature. Any number of cooling techniques may be used to reduce a temperature of a protein liquor. For example, in some embodiments heat exchange mechanisms may be used to cool a protein liquor. In some embodiments a cooled temperature may be selected due to a decreased level of protein degradation (e.g., 4° C.).

A protein liquor 305 may include one or more of a mixture of amino acids, peptides, and proteins (e.g., soluble, denatured). Persons skilled in the art would appreciate that a protein liquor 305 may include various amino acids and amino acid combinations, as well as, peptides and proteins of variable sizes and states. In some embodiments, a protein liquor may have a total amino acid content ranging from about 15 to about 50% on a dry matter basis (DMB). For example, a protein liquor may have a total amino acid content ranging from about 15 to about 20%, or about 20 to about 25%, or about 25 to about 30%, or about 30 to about 35%, or about 35 to about 40%, or about 40 to about 45%, or about 45 to about 50% DMB.

### Composition of a Milk Base

Some embodiments relate to a process for production of a milk base 312 from a protein liquor 305. In these embodiments, one or more processes may be optimized to achieve an appropriate blend and concentration of nutritional components, flavor, mouthfeel, color, and ionic strength necessary to be compatible with components such as emulsifiers when generating a microcrop milk 313. A process may be configured or performed to achieve any desired protein yield (e.g., maximal yield, a selected yield) of a milk base 312. In some embodiments, a protein concentration of a milk base 312 is higher than about 10%, or higher than about 20%, or higher than about 30%, or higher than about 40%, or higher than about 45%, or higher than about 50%, or higher than about 55%, or higher than about 60%, or higher than about 65%, or higher than about 70% by dry mass basis (DMB) of a milk base 312. A remainder of a milk base 312 may include carbohydrates, fiber, fats, minerals, or any combination thereof.

In some embodiments, a milk base 312 may have a fat content from about 10% to about 40% by DMB of the microcrop milk. A milk base 312 may have a fat content of at least 10%, or at least 15%, or at least 20%, or at least 25%, or at least 30%, or at least 35%, or at least 40% by DMB of the microcrop milk in some embodiments.

According to some embodiments, a milk base 312 may include an ash content consisting of a residue containing inorganic mineral elements. An ash content in some embodiments may be determined by combusting a milk base 312 at a high temperature (e.g., ≥500° C.) to remove organic matter. A milk base 312 may have an ash content lower than about 2%, or lower than about 4%, or lower than about 6%, or lower than about 8%, or lower than about 10%, or lower than about 12%, or lower than about 13%, or lower than about 1% to about 15% by DMB of the milk base 312 in some embodiments.

According to some embodiments, a milk base 312 may have a carbohydrate of between about 10% and about 55% by DMB of the microcrop milk. A milk base 312 may have a carbohydrate content of about 10%, or about 15%, or about 20%, or about 25%, or about 30%, or about 35%, or about 40%, or about 45%, or about 50%, or about 55% by DMB of the microcrop milk, in some embodiments.

According to some embodiments, a milk base 312 may include Vitamin B12. In some embodiments, a milk base 312 may include one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

In some embodiments, a milk base may have a composition that is between about 25% and 65% protein, about 10% and 30% ash, about 0% and 10% fat, about 10% and 25% carbohydrates and other materials, and about 3 μg/100 g and 50 μg/100 g Vitamin B12. For example, milk bases A, B, C, D, and E produced by the processes described herein may include the contents summarized in Table 3 below.

TABLE 3

| Composition | Milk base A | Milk base B | Milk base C | Milk base D | Milk base E |
|---|---|---|---|---|---|
| Protein | 60% | 43% | 32% | 25% | 39% |
| Ash | 25% | 26% | 50% | 52% | 35% |
| Fat | 5% | 9% | 4% | 10% | 8% |
| Carbs/Other | 10% | 22% | 14% | 13% | 18% |
| Vitamin B12 | 17 ug/100 g | 9 ug/100 g | 3 ug/100 g | 22 ug/100 g | 30 ug/100 g |

According to some embodiments, a milk base 312 may be consumed and may constitute a product without further processing.

### Composition of an Electrolyte Drink

Some embodiments relate to a process for production of an electrolyte drink 330 from a protein liquor 305. In these embodiments, one or more processes may be optimized to achieve an appropriate blend and concentration of nutritional components, flavor, mouthfeel, color, and/or to maximize mineral content without the constraints on ionic strength which may be present when generating a microcrop milk 313. In some embodiments, an electrolyte drink 330 may have a higher ionic concentration than a milk base 312. A process may be configured or performed to achieve any desired protein yield (e.g., maximal yield, a selected yield) of an electrolyte drink 330. In some embodiments, a protein concentration of an electrolyte drink 330 is higher than about 10%, or higher than about 20%, or higher than about 30%, or higher than about 40%, or higher than about 45%, or higher than about 50%, or higher than about 55%, or higher than about 60%, or higher than about 65%, or higher than about 70% by dry mass basis (DMB) of an electrolyte drink 330. A remainder of an electrolyte drink 330 may include carbohydrates, fiber, fats, minerals, or any combination thereof.

In some embodiments, an electrolyte drink 330 may have a fat content from about 10% to about 40% by DMB of the electrolyte drink. An electrolyte drink 330 may have a fat content of at least 10%, or at least 15%, or at least 20%, or at least 25%, or at least 30%, or at least 35%, or at least 40% by DMB of the electrolyte drink in some embodiments.

According to some embodiments, an electrolyte drink 330 may include an ash content consisting of a residue containing inorganic mineral elements. An ash content in some embodiments may be determined by combusting an electrolyte drink 330 at a high temperature (e.g., ≥500° C.) to remove organic matter. An electrolyte drink 330 may have an ash content lower than about 2%, or lower than about 4%, or lower than about 6%, or lower than about 8%, or lower than about 10%, or lower than about 12%, or lower than about 13%, or lower than about 1% to about 15% by DMB of the electrolyte drink 330 in some embodiments.

According to some embodiments, an electrolyte drink 330 may have a carbohydrate of between about 10% and about 55% by DMB of the electrolyte drink. An electrolyte drink 330 may have a carbohydrate content of about 10%, or about 15%, or about 20%, or about 25%, or about 30%, or about 35%, or about 40%, or about 45%, or about 50%, or about 55% by DMB of the electrolyte drink, in some embodiments.

According to some embodiments, an electrolyte drink 330 may include Vitamin B12. In some embodiments, an electrolyte drink 330 may include one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

In some embodiments, an electrolyte drink may have a composition that is between about 15% and 45% protein, about 15% and 60% ash, about 0% and 10% fat, about 15% and 55% carbohydrates and other materials, and about 3 μg/100 g and 50 μg/100 g Vitamin B12. For example, electrolyte drinks A, B, C, D, and E produced by the processes described herein may include the contents summarized in Table 4 below.

TABLE 4

| | Electrolyte | Electrolyte | Electrolyte | Electrolyte | Electrolyte |
|---|---|---|---|---|---|
| Composition | Drink A | Drink B | Drink C | Drink D | Drink E |
| Protein | 15% | 43% | 32% | 25% | 39% |
| Ash | 25% | 26% | 49% | 23% | 35% |
| Fat | 5% | 9% | 4% | 7% | 8% |
| Carbs/Other | 55% | 22% | 15% | 45% | 18% |
| Vitamin B12 | 17 ug/100 g | 9 ug/100 g | 3 ug/100 g | 22 ug/100 g | 30 ug/100 g |

### Systems and Methods of Generating a Microcrop Milk

In some embodiments, a milk base 312 may be further processed to generate a microcrop milk 332.

### Amending a Milk Base

A method may comprise amending a milk base 312 to produce an amended milk base 316. According to some embodiments, amending a milk base 312 to produce an amended milk base 316 may comprise one or more of adding a fat component 214, adding an emulsifier 218, and adding an enhancer 222.

According to some embodiments, adding a fat component 214214 may comprise the addition of a fat component to a milk base 312 in order to produce a microcrop milk 332 with a consistency that is closer to a more traditional, dairy-based milk product. A fat component may comprise one or more of palm oil, coconut oil, avocado oil, almond oil, hemp oil, soybean oil, sunflower oil, canola oil, oat oil, cashew oil, peanut oil, pea oil, quinoa oil, rice bran oil, barely oil, or other plant- or nut-based oil. In some embodiments, a fat component may comprise a dairy-based fat such as milk fat from a mammalian milk. According to some embodiments, a fat component may include omega-3 oils derived from marine organisms such as fish, krill, and algae. In some embodiments, a fat component m [ay have animal origin (e.g., butterfat) or be a fat substitute (e.g., low or zero calorie). Persons having skill in the art would understand that the any number of animal based, plant based, and artificial fats may be used to amend a milk base 312 without deviating from the present disclosure. Moreover, various forms of fat additives (e.g., bulk and powdered fats) are within the scope of the present disclosure.

Adding an emulsifier 218 may comprise the addition of an emulgent (i.e., emulsifier, emulsifying agent) to a milk base 312 to produce a microcrop milk 332 that is less likely to separate into a fat component and milk base after an addition of a fat component 214 and homogenization 124. An emulsifier may comprise, without limitation, one or more of mustard, soy lecithin, egg lecithin, monoglycerides, diglycerides, polysorbates, carrageenan, guar gum, canola oil, calcium stearoyl-2-lactylate. polyglycerol esters, sorbitan esters, PG esters, sugar esters, acetylated monoglycerides, lactylated monoglycerides, or other plant-derived, animal-derived, synthetic emulsifiers, and/or any other suitable compound with emulsification properties.

According to some embodiments, a method 100 may include amending a milk base 312 by adding one or more enhancers. Enhancers (e.g., flavoring, color augmentator) 222 may be added to the milk base 312 to alter (e.g., improve) the flavor, taste, mouth feel, smell, appearance, or useful life of the microcrop milk 332. Enhancers 222 may comprise any combination of flavors, dyes, or other agents, which are meant to improve the flavor, taste, mouth feel, smell, appearance, or shelf-life of the microcrop milk 332. By way of example, and not limitation, enhancers 222 may include sugars, natural and artificial coloring agents, honey, monosodium glutamate, salts, nut oils, diary or non-dairy milks, artificial sweetening substances, color retention agents, thickeners, preservatives, and other natural or artificial flavoring or coloring agents, and preservatives. In some embodiments, enhancers 222 may be added to an amended milk base 316 to produce a microcrop milk 332. Addition of enhancers 222 may occur before or after homogenization 124. In some embodiments, enhancers 222 are not added at all.

### Homogenization

A method of producing a microcrop milk may include homogenization 124 of an amended milk base 316 to produce a microcrop milk 332. Homogenization 124 may be achieved by using one or more of: homogenizers, homogenization valves, colloid mills, or other means of converting two immiscible liquids (i.e., a milk base 312 and fat component 214) into an emulsion.

### Composition of a Microcrop Milk

Some embodiments relate to a process for production of a microcrop milk 332 from a biomass of a harvested microcrop (e.g., aquatic plant species, Lemna, algal species). A process may be configured or performed to achieve any desired protein yield (e.g., maximal yield, a selected yield) of a microcrop milk 332. In some embodiments, a protein concentration of a microcrop milk 332 is higher than about 10%, or higher than about 20%, or higher than about 30%, or higher than about 40%, or higher than about 45%, or higher than about 50%, or higher than about 55%, or higher than about 60%, or higher than about 65%, or higher than about 70% by dry mass basis (DMB) of a microcrop milk 332. A remainder of a microcrop milk 332 may include carbohydrates, fiber, fats, minerals, or any combination thereof.

In some embodiments, a microcrop milk 332 may have a fat content from about 10% to about 40% by DMB of the microcrop milk. A microcrop milk 332 may have a fat content of at least 10%, or at least 15%, or at least 20%, or at least 25%, or at least 30%, or at least 35%, or at least 40% by DMB of the microcrop milk in some embodiments.

According to some embodiments, a microcrop milk 332 may include an ash content consisting of a residue containing inorganic mineral elements. An ash content in some embodiments may be determined by combusting a microcrop milk 332 at a high temperature (e.g., ≥500° C.) to remove organic matter. A microcrop milk 332 may have an ash content lower than about 2%, or lower than about 4%, or lower than about 6%, or lower than about 8%, or lower than about 10%, or lower than about 12%, or lower than about 13%, or lower than about 1% to about 15% by DMB of the microcrop milk 332 in some embodiments.

According to some embodiments, a microcrop milk 332 may have a carbohydrate of between about 10% and about 55% by DMB of the microcrop milk. A microcrop milk 332 may have a carbohydrate content of about 10%, or about 15%, or about 20%, or about 25%, or about 30%, or about 35%, or about 40%, or about 45%, or about 50%, or about 55% by DMB of the microcrop milk, in some embodiments.

According to some embodiments, a microcrop milk 332 may include Vitamin B12. In some embodiments, a microcrop milk 332 may include one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

In some embodiments, a microcrop milk may have a composition that is between about 30% and 55% protein, about 5% and 15% ash, about 20% and 36% fat, about 10% and 45% carbohydrates and other materials, and about 3 μg/100 g and 30 μg/100 g Vitamin B12. For example, microcrop milks A, B, C, D, and E produced by the processes described herein may include the contents summarized in Table 5 below.

TABLE 5

| | Microcrop | Microcrop | Microcrop | Microcrop | Microcrop |
|---|---|---|---|---|---|
| Composition | Milk A | Milk B | Milk C | Milk D | Milk E |
| Protein | 32% | 55% | 30% | 37% | 44% |
| Ash | 5% | 5% | 8% | 10% | 5% |
| Fat | 20% | 25% | 34% | 21% | 24% |
| Carbs/Other | 43% | 15% | 28% | 32% | 27% |
| Vitamin B12 | 14 ug/100 g | 22 ug/100 g | 3 ug/100 g | 17 ug/100 g | 9 ug/100 g |

### Methods and Systems for Generating a Dried Base Powder

In some embodiments, a milk base 312 and/or an electrolyte drink may be further processed to generate a dried base powder 334.

### Drying a Milk Base to Generate a Dried Base Powder

A milk base 312 and/or an electrolyte drink 330 may be dried to generate a dried base powder 334. A drying procedure 134, in some embodiments, may reduce the moisture content of a milk base 312 and/or an electrolyte drink 330 to a desired level (e.g., lower moisture content, a desired moisture content). A moisture content of a dried base powder 334 may be, for example, below about 95%, or below about 90%, or below about 80%, or below about 70%, or below about 60%, or below about 50%, or below about 40%, or below about 30%, or below about 20%, or below about 10%, or below about 5%, or below about 1% by weight of the dried base powder 334, in some embodiments. A drying procedure 120 may be performed using a mechanism including, for example, a spray dryer (preferred), a drum dryer, a double drum dryer, flash dryer, a fluid-bed dryer, a convection dryer, an evaporator, or any combination thereof.

In some embodiments, an inlet temperature of a dryer mechanism (the temperature at the entrance to a dryer) may be above 25° C., or above 50° C., or above 75° C., or above 100° C., or above 125° C., or above 150° C., or above 175° C., or above 200° C., or above 225° C., or above 250° C., or above 275° C., or above 300° C., or above 325° C., or above 350° C., or above 375° C., or above 400° C., or above 425° C., or above 450° C., or above 475° C., or above 500° C. An inlet temperature, in some embodiments, may be from about 25° C. to about 50° C., or from about 50° C. to about 75° C., or from about 75° C. to about 100° C., or from about 100° C. to about 125° C., or from about 125° C. to about 150° C., or from about 150° C. to about 175° C., or from about 175° C. to about 200° C., or from about 200° C. to about 225° C., or from about 225° C. to about 250° C., or from about 250° C. to about 275° C., or from about 275° C. to about 300° C., or from about 300° C. to about 325° C., or from about 325° C. to about 350° C., or from about 350° C. to about 375° C., or from about 375° C. to about 400° C., or from about 400° C. to about 425° C., or from about 425° C. to about 450° C., or from about 450° C. to about 475° C., or from about 475° C. to about 500° C., or above 500° C. An inlet temperature may be from about 50° C. to about 100° C., or from about 100° C. to about 150° C., or from about 150° C. to about 200° C., or from about 200° C. to about 250° C., or from about 250° C. to about 300° C., or from about 300° C. to about 350° C., or from about 350° C. to about 400° C., or from about 400° C. to about 450° C., or from about 450° C. to about 500° C., or above 500° C., in some embodiments. According to some embodiments, an inlet temperature of a dryer mechanism may be about 225° C.

According to some embodiments, an outlet temperature of a dryer mechanism (the temperature at the exit from a dryer) may be below about 300° C., or below about 275° C., or below about 250° C., or below about 225° C., or below about 200° C., or below about 175° C., or below about 150° C., or below about 125° C., or below about 100° C., or below about 75° C., or below about 50° C., or below about 25° C. An outlet temperature may be from about 300° C. to about 275° C., or from about 275° C. to about 250° C., or from about 250° C. to about 225° C., or from about 225° C. to about 200° C., or from about 200° C. to about 175° C., or from about 175° C. to about 150° C., or from about 150° C. to about 125° C., or from about 125° C. to about 100° C., or from about 100° C. to about 75° C., or from about 75° C. to about 50° C., or from about 50° C. to about 25° C., or below about 25° C., in some embodiments. An outlet temperature, in some embodiments, may be from about 300° C. to about 250° C., or from about 250° C. to about 200° C., or from about 200° C. to about 150° C., or from about 150° C. to about 100° C., from about 100° C. to about 50° C., or from about 50° C. to about 25° C., or below about 25° C. According to some embodiments, an outlet temperature of a dryer mechanism may be about 75° C.

As shown in FIG. 1B, a dried base powder 334 may be reconstituted with water to generate either a milk base 312, which may be further processed to generate a microcrop milk 332, or may be reconstituted with water to generate an electrolyte drink 330.

### Composition of a Dried Base Powder

Some embodiments relate to a process for production of a dried base powder 334 from a protein liquor 305. A process may be configured or performed to achieve any desired protein yield (e.g., maximal yield, a selected yield) of a dried base powder 334. In some embodiments, a protein concentration of a dried base powder 334 is higher than about 10%, or higher than about 20%, or higher than about 30%, or higher than about 40%, or higher than about 45%, or higher than about 50%, or higher than about 55%, or higher than about 60%, or higher than about 65%, or higher than about 70% by dry mass basis (DMB) of a dried base powder 334. A remainder of a dried base powder 334 may include carbohydrates, fiber, fats, minerals, or any combination thereof.

In some embodiments, a dried base powder 334 may have a fat content from about 10% to about 40% by DMB of the microcrop milk. A dried base powder 334 may have a fat content of at least 10%, or at least 15%, or at least 20%, or at least 25%, or at least 30%, or at least 35%, or at least 40% by DMB of the dried base powder in some embodiments.

According to some embodiments, a dried base powder 334 may include an ash content consisting of a residue containing inorganic mineral elements. An ash content in some embodiments may be determined by combusting a dried base powder 334 at a high temperature (e.g., ≥500° C.) to remove organic matter. A dried base powder 334 may have an ash content lower than about 2%, or lower than about 4%, or lower than about 6%, or lower than about 8%, or lower than about 10%, or lower than about 12%, or lower than about 13%, or lower than about 1% to about 15% by DMB of the dried base powder 334 in some embodiments.

According to some embodiments, a dried base powder 334 may have a carbohydrate of between about 10% and about 55% by DMB of the dried base powder 334. A dried base powder 334 may have a carbohydrate content of about 10%, or about 15%, or about 20%, or about 25%, or about 30%, or about 35%, or about 40%, or about 45%, or about 50%, or about 55% by DMB of the dried base powder 334, in some embodiments.

According to some embodiments, a dried base powder 334 may include Vitamin B12. In some embodiments, a dried base powder 334 may include one or more bioactive forms of Vitamin B12 (e.g., Adenosylcobalamin, Hydroxycobalamin, and Methylcobalamin). A concentration of Vitamin B12 may range from about 0.1 ug/100 g (DWB) to about 200 ug/100 g. For example, a concentration of bioactive Vitamin B12 may be between about 0.1 to about 0.5 ug/100 g, or about 0.5 to about 1 ug/100 g, or about 1 to about 5 ug/100 g, or about 5 to about 10 ug/100 g, or about 10 to about 20 ug/100 g, or about 20 to about 30 ug/100 g, or about 30 to about 40 ug/100 g, or about 40 to about 50 ug/100 g, or about 50 to about 60 ug/100 g, or about 60 to about 70 ug/100 g, or about 70 to about 80 ug/100 g, or about 80 to about 90 ug/100 g, or about 90 to about 100 ug/100 g, or about 100 to about 110 ug/100 g, or about 110 to about 120 ug/100 g, or about 120 to about 130 ug/100 g, or about 130 to about 140 ug/100 g, or about 140 to about 150 ug/100 g, or about 150 to about 160 ug/100 g, or about 160 to about 170 ug/100 g, or about 170 to about 180 ug/100 g, or about 180 to about 190 ug/100 g, or about 190 to about 200 ug/100 g. In some embodiments, a Vitamin B12 content may range from about 0.0000001% to about 0.0000005% (DWB), or about 0.0000005% to about 0.000001%, or about 0.000001% to about 0.000005%, or about 0.000005% to about 0.00001%, or about 0.00001% to about 0.00002%, or about 0.00002% to about 0.00003%, or about 0.00003% to about 0.00004%, or about 0.00004% to about 0.00005%, or about 0.00005% to about 0.00006%, or about 0.00006% to about 0.00007%, or about 0.00007% to about 0.00008%, or about 0.00008% to about 0.00009%, or about 0.00009% to about 0.0001%, or about 0.0001% to about 0.00011%, or about 0.00011% to about 0.00012%, or about 0.00012% to about 0.00013%, or about 0.00013% to about 0.00014%, or about 0.00014% to about 0.00015%, or about 0.00015% to about 0.00016%, or about 0.00016% to about 0.00017%, or about 0.00017% to about 0.00018%, or about 0.00018% to about 0.00019%, or about 0.00019% to about 0.0002%.

In some embodiments, a dried base powder may have a composition that is between about 15% and 60% protein, about 10% and 60% ash, about 0% and 10% fat, about 15% and 55% carbohydrates and other materials, and about 3 μg/100 g and 50 μg/100 g Vitamin B12. For example, dried base powders A, B, C, D, and E produced by the processes described herein may include the contents summarized in Table 6 below.

TABLE 6

| Estimated | | | | | |
|---|---|---|---|---|---|
| Proximate | Dried Base | Dried Base | Dried Base | Dried Base | Dried Base |
| Composition | Powder A | Powder B | Powder C | Powder D | Powder E |
| Protein | 25% | 15% | 43% | 37% | 60% |
| Ash | 40% | 25% | 18% | 10% | 15% |
| Fat | 1% | 5% | 7% | 10% | 4% |
| Carbs/Other | 34% | 55% | 32% | 43% | 21% |
| Vitamin B12 | 22 ug/100 g | 17 ug/100 g | 18 ug/100 g | 9 ug/100 g | 38 ug/100 g |

### EXAMPLES

### Example 1

A protein liquor was prepared by cultivating Lemna in a growth medium including water and nutrients. The microcrop was harvested and the biomass washed with a wash solution of chlorinated or ozonated well water. The wash solution was removed by vibratory screening of the biomass. The wet biomass was lysed using a shear mill and separated into a juice and a solid using a decanter centrifuge. The juice was filtered using a high speed disc stack centrifuge to remove fine particulates and generate a protein liquor.

### Example 2

A first aliquot of the protein liquor of Example 1 was subjected to acid precipitation and subsequently ultrafiltered using a 1 KDa molecular weight cut off (MWCO) filter. The composition of the resulting demineralized protein is shown as Product A below in Table 7.

A second aliquot of the protein liquor of Example 1 was subjected to acid precipitation and subsequently nanofiltered using a 300-500 Da (MWCO) filter. The composition of the resulting demineralized protein Product B is shown below in Table 7.

A third aliquot of the protein liquor of Example 1 was subjected to ultrafiltration using a 5 KDa MWCO filter and subsequently nanofiltered using a 300-500 Da MWCO filter. The composition of the resulting demineralized protein Product C is shown below in Table 7.

TABLE 7

| Component | Product A | Product B | Product C |
|---|---|---|---|
| Protein | 50-55% | 35-40% | 25-28% |
| Ash | <13% | <25% | 44-48% |
| Fat | <5% | <1% | <1% |
| Carbs/Other | Balance | Balance | Balance |
| Vitamin B12 | 3-50 ug/100 g | 3-50 ug/100 g | 3-50 ug/100 g |

### Example 3

Products A and C in liquid form, at a total dissolved solids concentration of 2%, were made under food grade conditions in a pilot process, collected in aseptic containers and refrigerated. They were found to have a very mild, pleasant flavor. After two weeks of refrigeration the products were tested for any changes in flavor, pH and microbial load and found to be stable. The products were further treated with fruit flavorings such as mango and found to be enjoyable as a fruit-flavored drink. Product A is an example of a high-protein, low-mineral electrolyte drink, while Product C is an example of a low-protein, high-mineral electrolyte drink.

### Example 4

Product B of Example 2 was dried to generate a dried base powder. The dried base powder was processed to make a microcrop milk as follows: 0.3 g lecithin was added to 92 g of water and homogenized at 25,000 rpm for 3 minutes; 5 g of Product B dried base powder was added to the water/lecithin mixture and homogenized until the Product B dried base powder was dissolved; and 3 g of medium chain triglyceride (MCT) coconut oil was added to the resulting mixture and homogenized at 25,000 rpm for 3 min. The resulting microcrop milk was a palatable drink with a color and consistency similar to almond milk.

Persons skilled in the art may make various changes without departing from the scope of the instant disclosure. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure. Where desired, some embodiments of the disclosure may be practiced to the exclusion of other embodiments.

Also, where ranges have been provided, the disclosed endpoints may be treated as exact and/or approximations (e.g., read without or with “about”) as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In some embodiments, variation may simply be +/−10% of the specified value. In addition, it may be desirable, in some embodiments, to mix and match range endpoints. Also, in some embodiments, each figure disclosed (e.g., in one or more of the examples, tables, and/or drawings) may form the basis of a range (e.g., depicted value +/−about 10%, depicted value +/−about 50%, depicted value +/−about 100%) and/or a range endpoint. With respect to the former, a value of 50 depicted in an example, table, and/or drawing may form the basis of a range of, for example, about 45 to about 55, about 25 to about 100, and/or about 0 to about 100.

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

What is claimed is:

1. A method comprising:
demineralizing a protein liquor to generate a demineralized protein liquor,
wherein the protein liquor comprises a liquid portion of a lysed microcrop that has been separated to generate the liquid portion and a solid portion, and
wherein the protein liquor comprises a soluble microcrop protein and a Vitamin B12.

2. The method of claim 1 wherein the demineralizing the protein liquor comprises at least one of:
diafiltration of the protein liquor,
ultrafiltration of the protein liquor,
nanofiltration of the protein liquor,
reverse osmosis filtration of the protein liquor, and
passing the protein liquor through an ion exchange resin.

3. The method of claim 2 wherein the demineralizing the protein liquor comprises passing the protein liquor through an ion exchange filter comprising an anion exchange resin.

4. The method of claim 3 wherein the anion exchange resin comprises a trialkyl ammonium salt having three methyl groups.

5. The method of claim 1 further comprising at least one of:
subjecting the protein liquor to an adsorption process prior to demineralizing;
adjusting a calcium concentration of the protein liquor prior to demineralizing; and
filtering the protein liquor to remove insoluble materials prior to demineralizing.

6. The method of claim 5, wherein the adsorption process comprises at least one of mixing a resin with the protein liquor and passing the protein liquor through a resin, wherein the resin comprises at least one of a hydrogen bonding polymer and a polyvinylpolypyrrolidone.

7. The method of claim 1 further comprising:
concentrating the demineralized protein liquor to generate at least one of a milk base and an electrolyte drink.

8. The method of claim 7 further comprising:
amending the milk base to generate an amended milk base; and
homogenizing the amended milk base to generate a microcrop milk,
wherein amending the milk base comprises at least one of:
adding a fat component,
adding an emulsifier, and
adding an enhancer.

9. The method of claim 7 further comprising:
drying at least one of the milk base and the electrolyte drink to generate a dried base powder.

10. The method of claim 1 further comprising:
lysing a microcrop to generate a lysed biomass;
separating the lysed biomass to generate a juice fraction and a solid fraction;
separating the juice fraction to generate the protein liquor.

11. The method of claim 10 further comprising:
hydrolyzing the lysed biomass prior to separating the lysed biomass.

12. The method of claim 1, wherein the microcrop is Lemna.

13. The method of claim 7 further comprising treating the milk base to reduce at least one of a microbial concentration and an enzymatic activity level.

14. A method of generating a microcrop beverage product, the method comprising:
lysing a microcrop to generate a lysed biomass;
separating the lysed biomass to generate a juice fraction and a solid fraction;
separating the juice fraction to generate a protein liquor;
demineralizing the protein liquor to generate a demineralized protein liquor;
concentrating the demineralized protein liquor to generate at least one of a milk base and an electrolyte drink.

15. The method of claim 14 further comprising at least one of:
subjecting the protein liquor to an adsorption process prior to demineralizing;
adjusting a calcium concentration of the protein liquor prior to demineralizing; and
filtering the protein liquor to remove insoluble materials prior to demineralizing.

16. The method of claim 15, wherein the adsorption process comprises at least one of mixing a resin with the protein liquor and passing the protein liquor through a resin, wherein the resin comprises at least one of a hydrogen bonding polymer and a polyvinylpolypyrrolidone.

17. The method of claim 14 further comprising:
amending the milk base to generate an amended milk base; and
homogenizing the amended milk base to generate a microcrop milk,
wherein amending the milk base comprises at least one of:
adding a fat component,
adding an emulsifier, and
adding an enhancer.

18. The method of claim 17 further comprising:
drying at least one of the milk base and the electrolyte drink to generate a dried base powder.

19. The method of claim 14 further comprising:
hydrolyzing the lysed biomass prior to separating the lysed biomass.

20. The method of claim 14, wherein the microcrop is Lemna.
